(19) United States
(12) Patent Application Publication
(10) Pub. No.: US 2025/0163693 A1
(43) Pub. Date: May 22, 2025

(54) VORTEX FLOW CONTROL DEVICE

(71) Applicant: FREEFLUSH LIMITED, Manchester, Greater Manchester (GB)

(72) Inventor: Junaid PATEL, Manchester (GB)

(21) Appl. No.: 18/841,929

(22) PCT Filed: Feb. 28, 2023
(86) PCT No.: PCT/GB2023/050444

§ 371 Date: Aug. 27, 2024

(30) Foreign Application Priority Data
Feb. 28, 2022 (GB) 2202702.3
Dec. 13, 2022 (GB) 2218762.9

(51) Int. Cl. E03F 5/10

(52) U.S. Cl. CPC E03F 5/106

(57) ABSTRACT

A vortex flow control device (2) comprises a chamber (20), having a first end (21), a second end (22), an inlet (23) proximal to and/or at the first end (21) and an outlet (24) proximal to and/or at the second end (22), wherein the first end (21) and the second end (22) are mutually opposed and wherein the inlet (23) and the outlet (24) are mutually orthogonal; wherein the chamber (20) defines a first cylindrical volume CV1 proximal to and/or at the first end (21) and wherein the inlet (23) is tangential to the first cylindrical volume CV1; and wherein the chamber (20) defines a tapered volume TV disposed between the first cylindrical volume CV1 and the outlet (24).

### FIELD

The present invention relates to flow control devices.

### BACKGROUND TO THE INVENTION

Frequency and/or severity of flooding of urban areas has increased, particularly during periods of heavy rainfall. This flooding may be attributed to increased urban development and global climate change. Urban development has transformed green field sites into residential, commercial and/or industrial property. Previously, rainfall on these green field sites infiltrated into the ground. Increased urban development has interrupted this infiltration due to use of impermeable materials such as concrete, tarmac, asphalt and/or roofing. Instead, rainfall is conveyed as surface water runoff to water courses, for example streams or rivers, and/or a water drainage system, for example storm water drainage systems. This increased runoff coupled with global climate change has led to increased flooding due to conventional storm water drainage systems being overloaded.

Hence, discharge of surface water into a drainage system may be regulated. Surface water includes water from precipitation such as rain or snow falling on a property or curtilage that has not seeped into the ground, for example, and is discharged into the drainage system. A flow rate capacity of the drainage system may, for example, be sufficient for surface water resulting from typical rainfalls. However, the flow rate capacity of the drainage system may, for example, be insufficient for surface water resulting from atypical rainfalls, such as sustained rainfall or storms. That is, a discharge flow rate of surface water into the drainage system may be in excess of the flow rate capacity of the drainage system. So as not exceed the flow rate capacity of the drainage system, discharge of surface water from residential, commercial, industrial or agricultural property or curtilage into the drainage system may be controlled by mandating maximum discharge flow rates of surface water into the drainage system.

Sustainable Urban Drainage Systems (SuDS) is a direct response to the problem of flash flooding and is defined by the Construction Industry Research and Information Association (CIRIA) as “a sequence of management practices and control structures designed to drain surface water in a more sustainable fashion than some conventional techniques”. These techniques are as applicable to rural settings as they are to urban areas. Using SuDS techniques, water is either infiltrated or conveyed more slowly to water courses via ponds, swales, infiltration systems, attenuation tanks or other installations to try and closely mimic natural catchment drainage behaviour. Runoff is frequently delayed in natural ponds or hollows.

In addition to delaying the rate of runoff, there is more likelihood in the natural situation that pollutants will be filtered through soils or broken down by bacteria. By mimicking this, SuDS attenuates stormwater runoff and improves environmental performance.

There are eight main methods by which a Sustainable Urban Drainage System may be implemented:
i. Permeable Pavements: Use of porous asphalt, porous paving or similar concepts to reduce imperviousness thus minimising runoff. Runoff infiltrates to a stone reservoir where some breakdown of pollutants occurs before controlled discharge to a drain or watercourse or direct infiltration.
ii. Filter Drains: A gravel filled trench, generally with a perforated pipe at the base which conveys runoff to a drain or watercourse. These provide attenuation and trap sediments.
iii. Infiltration Trenches/Soak-away: Gravel or specially engineered trenches designed to store runoff while letting it infiltrate slowly to the ground. These provide treatment of runoff through filtration, absorption and microbial decomposition.
iv. Bio-Retention: These devices are depressions back filled with sand and soil and planted with native vegetation. They provide filtration, settlement and some infiltration. Typically under drained with remaining runoff piped back to the drainage system or watercourse.
v. Swales: Grass lined channels designed to convey water to infiltration or a watercourse. Delays runoff and traps pollutants via infiltration for filtering effects of vegetation.
vi. Detention Basins: Dry vegetated depressions which impound stormwater during an event and gradually release it. Mostly for volume control but some pollutant removal is achieved via settlement of suspended solids and some infiltration.
vii. Retention Ponds: Permanent water bodies which store excess water for long periods allowing particle settlement and biological treatment. Very effective for pollutant removal but limited to larger developments. Have high habitat and aesthetic benefits.
viii. Attenuation Tanks: Underground storage tanks on site, either of concrete or modular plastic construction. These tanks store the excess runoff during a rainstorm event and release it into the local storm drain or water course at a controlled rate through the use of a flow control device.

In more detail, in situations where infiltration is not suitable due to ground conditions, attenuation tanks provide control of peak storm water. Storage in the attenuation tanks allows surface water discharge from a developed site to mimic run off in its undeveloped state. A range of options are available and this choice will be influenced by a number of factors including drainage depth, ground water level, site topography, site usage (car park or building) and space available. All attenuation tanks require provision of a flow control device to mobilize the storage except where the runoff restriction is not onerous or where discharge to natural ground to replenish the ground water table is feasible. In all cases, the site condition and constraints, as well as discharge licenses stipulated by regulating body, must be properly understood before the preferred system can be specified. All of the systems are relatively easy to maintain, although certain modular systems and in situ attenuation tanks could allow silt to enter and may be more difficult to clean than conventional piped systems. Some modular systems recommend putting a large silt collection device upstream of the storage facility to catch the silt before it reaches the attenuation tank. The maximum discharge flow rates of surface water into the drainage system may be according to, for example, the flow rate capacity of the drainage system, a volume of surface water, a type or size of property or an area of curtilage. For example, a maximum discharge flow rate of surface water into the drainage system for a typical residential property may be mandated around 0.2 dm³s⁻¹. Typically, restrictors such as flow control devices may be provided to restrict maximum discharge flow rates of surface water into drainage systems. However, since surface water may be received by a property and/or curtilage at a rate higher than a mandated maximum rate of discharge into the drainage system, surface water may accumulate on or in the property and/or curtilage. Typically, attenuation tanks may be provided upstream of restrictors to hold accumulated surface water. The accumulated surface water may discharge at flow rates controlled by the restrictors and may, for example, continue to discharge after rain has lessened or ceased. In this way, restrictors and attenuation tanks together provide attenuation of surface water discharged into drainage systems, limiting peak flow rates and increasing durations of flow into the drainage systems.

### Conventional Flow Control Devices Include:

a. An orifice plate is typically a thin plate having an orifice (i.e. an aperture, a hole, a passageway, a perforation) therethrough, usually placed in a pipe in which fluid flows, and is the simplest type of flow control device. Flow is controlled based on Bernoulli's equation, relating the pressure of the fluid and the velocity of the fluid. As the velocity of the fluid increases due to the orifice, the pressure decreases and vice versa. At the orifice, the fluid is forced to converge, with the point of maximum convergence just after the physical orifice, at the vena contract a point. An orifice plate is relatively inexpensive and the diameter of the orifice may be readily calculated for a desired flow rate. However, a risk of blockage is relatively high due to the relatively small diameter of the orifice.
b. A flow valve comprises a central outlet pipe surrounded by a pressure chamber filled with air. The top part of the pressure chamber and its connection to the central outlet pipe are made of flexible rubber fabric; the rubber fabric is braced at the inlet and outlet of the centre pipe. Water pressure on the upper portion of the rubber fabric is propagated through the pressure chamber displacing the fabric at the outlet section. Thus, the hydraulic capacity of the outlet is throttled by the change in cross sectional area. The resultant effect is that the discharge through the flow valve remains constant and independent of pressure. Discharge is independent of fluid pressure. However, a risk of blockage is relatively high due to the relatively small diameter of the outlet pipe.
c. A Steinscruv flow regulator comprises a stationary, anchored screw shaped plate that is turned through 270° and installed in a pipe. In the part of the plate which fits against the bottom of the pipeline, there is an opening to release a certain specified base flow. The opening is sized so that the flow that passes through the regulator is sufficient to maintain the self cleaning velocity of the pipeline. Damming takes place when the inflow to the regulator exceeds the capacity of the base opening. The extent of this damming and the volume detained are dependent on the slope of the pipe. When the flow depth reaches the crown of the pipe, the flow capacity becomes practically equal to the unregulated capacity. It is possible to further regulate the flow by using several flow regulators in series. However, at full bore, flow tends to unregulated capacity while cost and complexity are relatively high.
d. A hydro-slide regulator controls flow by allowing the head of water in the detention facility to raise a float. This in turn opens an orifice the required amount to control the flow passing therethrough. The hydro-slide does not affect the flow until the flow approachs the set discharge limit, allowing fluid to be discharged to the watercourse for flows below the set point, hence slowing the build up of head in the detention tank and therefore maximizing the onsite detention volume. The design flow rate is reached for relatively low heads of water. However, a risk of blockage is relatively high due to the relatively small size of the orifice while cost and complexity are relatively high.
e. Vortex flow control devices were developed in the mid-1960's to control outflow from a storage structure. At low flow rates, fluid enters through the inlet and passes straight to the outlet without restriction. As the inlet flow increases due to upstream hydraulic head, an air-filled vortex is generated in the vortex flow control device, generating relatively high peripheral velocities and creating a back pressure. The back pressure restricts flow to the desired flow rate at a given head height. There are two main types of conventional vortex flow control devices: radial vortex flow control devices and conical vortex flow control devices. Both vortex flow control devices function on the same principle but have different geometries which give each their own benefits and advantages. FIG. 1A schematically depicts a conventional radial (also known as snail-shaped) vortex flow control device. FIG. 1B schematically depicts a conventional conical (also known as cone shaped) vortex flow control device. Radial vortex flow control devices are typically used for the control of stormwater from storage facilities. Radial vortex flow control devices are relatively less costly but require a sump to operate. The outlet cross sectional area is typically 3 to 6 times greater than that of an orifice plate, so risk of blockage is relatively reduced. Conical vortex flow control devices are typically used in combined sewer/stormwater systems and do not require a sump to operate. Performance of vortex flow control devices may be modified using an adjustable intake gate and/or a vortex suppressor pipe to draw additional air into the vortex. Vortex flow control devices have a unique head discharge characteristic: the head discharge curve is “S” shaped, as shown in FIG. 1C. FIG. 1C shows a typical discharge curve of a conventional vortex flow control device, showing a bistable characteristic thereof. At relatively low heads, the discharge coefficient is relatively large, allowing water to flow relatively freely therethrough. At a predetermined head for the particular vortex flow control device, a vortex begins to form within the chamber, decreasing the discharge coefficient and thereby attenuating the flow of the water. The characteristic kickback in the discharge curve represents a transitional phase, in which the discharge coefficient is reduced as the vortex becomes fully formed. Once fully formed, the vortex establishes a relatively reduced though stable discharge coefficient of a stable phase. The flush point is that point of the discharge curve at which the initial flow peaks. Preferably, for a conventional vortex flow control device, the flush point is close to, but does not exceed, the design flow. The initiation point is that point of the discharge curve at which the vortex becomes fully formed and the discharge coefficient is stable. The design head is the head at which the design flow is to be achieved. For a conventional vortex flow control device, the design head is above the initiation point. The design flow is the maximum discharge rate. Preferably, for a conventional vortex flow control device, the design flow is in the stable region above the initiation point. The design of a conventional vortex flow control device may be varied to alter the head at which the flush point and the initiation point occur. For example, reducing the casing diameter of a radial vortex flow control device or reducing the cone angle of a conical vortex flow control device will lower the head required for initiation. However, such variations in design must be specified a priori for a particular installation. Furthermore, installation of vortex flow control devices into standard storm water manholes is relatively complex.

Hence, there is a need to improve attenuation of surface water discharged into drainage systems.

### SUMMARY OF THE INVENTION

It is one aim of the present invention, amongst others, to provide a vortex flow control device which at least partially obviates or mitigates at least some of the disadvantages of the prior art, whether identified herein or elsewhere. For instance, it is an aim of embodiments of the invention to provide a vortex flow control device having an improved performance. In this way, attenuation of surface water discharged into drainage systems may be improved.

A first aspect provides a vortex flow control device comprising a chamber, having a first end, a second end, an inlet proximal to and/or at the first end and an outlet proximal to and/or at the second end, wherein the first end and the second end are mutually opposed and wherein the inlet and the outlet are mutually orthogonal;
wherein the chamber defines a first cylindrical volume proximal to and/or at the first end and
wherein the inlet is tangential to the first cylindrical volume; and
wherein the chamber defines a tapered volume disposed between the first cylindrical volume and the outlet.

A second aspect provides a flow control chamber comprising a vortex flow control device according to the first aspect.

A third aspect provides an attenuation tank comprising a vortex flow control device according to the first aspect.

### DETAILED DESCRIPTION OF THE INVENTION

According to the present invention there is provided a vortex flow control device, as set forth in the appended claims. Also provided is a flow control chamber. Other features of the invention will be apparent from the dependent claims, and the description that follows.

### Vortex Flow Control Device

The first aspect provides a vortex flow control device comprising a chamber, having a first end, a second end, an inlet proximal to and/or at the first end and an outlet proximal to and/or at the second end, wherein the first end and the second end are mutually opposed and wherein the inlet and the outlet are mutually orthogonal;
wherein the chamber defines a first cylindrical volume proximal to and/or at the first end and
wherein the inlet is tangential to the first cylindrical volume; and
wherein the chamber defines a tapered volume disposed between the first cylindrical volume and the outlet.

In this way, the vortex flow control device has an improved performance compared with conventional vortex flow control devices. In this way, attenuation of surface water discharged into drainage systems is improved. Particularly, the inventor has synergistically combined a cylindrical inlet volume of a conventional radial vortex flow control device and a tapered outlet volume of a conventional conical vortex flow control device in an unique geometry. Without wishing to be bound by any theory, vortex flow is initially generated in the first cylindrical volume and further generated in the tapered volume, thereby generating relatively high peripheral velocities and creating a back pressure that restricts flow for a relatively broader range of desired flow rates for a relatively broader range of given head heights. The vortex flow control device does not require a sump to operate, unlike a conventional radial vortex flow control device, while is relatively less costly than a conventional conical vortex flow control device. Advantageously, the design flow and the design head of the vortex flow control device are relatively independent of the diameter of the first cylindrical volume and/or the taper angle (for example conical angle) of the tapered volume (for example conical volume), in contrast with conventional radial vortex flow control devices and conventional conical vortex flow control devices, respectively. Rather, the design flow and the design head of the vortex flow control device may be varied by varying the respective cross-sectional areas of the inlet and/or the outlet, thereby altering the head at which the flush point and the initiation point occur. In other words, as described below in more detail, the design flow and the design head of the vortex flow control device may be varied by varying the inlet diameter or by varying the outlet diameter or both varying the inlet diameter and the outlet diameter. In contrast with conventional radial vortex flow control devices and conventional conical vortex flow control devices, such variations in the respective cross-sectional areas of the inlet and/or the outlet may be used to adapt a relatively limited number of standard sizes, may be performed in situ for a particular installation and/or may be reselected if design requirements change, such as increased or decreased attenuation. Furthermore, installation of vortex flow control devices into standard storm water manholes is facilitated. As with conventional radial vortex flow control devices and conventional conical vortex flow control devices, the inlet and the outlet are relatively large compared with an orifice plate, so risk of blockage is similarly relatively reduced.

It should be understood that the vortex flow control device is suitable for vortex flow control of a fluid such as a liquid, for example water or surface water. It should be understood that water and/or surface water may comprise solids for example suspended solids such as organic or inorganic particulates and/or debris including non-buoyant debris such as stones, sand or soil and/or buoyant debris such as leaves or wood. It should be understood that water and/or surface water may comprise contaminants for example liquid contaminants such as oil. It should be understood that the fluid may comprise a gas, for example air.

### Chamber

The vortex flow control device comprises the chamber (i.e. a lumen; also known as volute). The chamber defines the first cylindrical volume proximal to and/or at the first end. The chamber defines the tapered volume disposed between the first cylindrical volume and the outlet. It should be understood that the tapered volume tapers inwardly towards the outlet i.e. such that a cross-sectional area of the tapered volume reduces towards the outlet and hence reduces in a direction of flow of a fluid therethrough. This is consistent with conventional conical vortex flow control devices.

It should be understood that the chamber, defining the first cylindrical volume proximal to and/or at the first end and the tapered volume disposed between the first cylindrical volume and the outlet, comprises and/or is a single chamber, having no partitions or obstructions therein. It should be understood that a total internal volume of the chamber comprises the first cylindrical volume and the tapered volume. In one example, the total internal volume of the chamber consists of the first cylindrical volume and the tapered volume. In one example, the total internal volume of the chamber comprises the first cylindrical volume, the tapered volume and a second cylindrical volume, for example proximal to and/or at the second end as described below. In one example, the total internal volume of the chamber consists of the first cylindrical volume, the tapered volume and the second cylindrical volume, for example proximal to and/or at the second end as described below. It should be understood that the first cylindrical volume and the tapered volume are internal volumes of the chamber. That is, an external shape of the chamber may correspond with the internal volume(s) of the chamber or may differ therefrom.

In one example, the vortex flow control device comprises and/or is a moulded and/or a monolithic (i.e. unitary, one-piece) vortex flow control device, for example provided by moulding a composite material (such as concrete or a fibre reinforced composite), a ceramic (such as clay) or a polymeric composition comprising a thermoplastic polymer. Polymeric compositions comprising thermoplastics may be readily formed, for example by extrusion, moulding or injection moulding, to provide the chamber. Such polymeric compositions may have appropriate mechanical properties suitable for subterranean installations, including loads as described above. Such polymeric compositions may have appropriate chemical properties suitable for resistance to the environment. For example, such polymeric compositions may be resistant to chemicals, such as oils and/or leachates. In addition, such polymeric compositions may be stabilised for resistance to UV light and/or ozone, for example. The thermoplastic polymer may be selected from a group consisting of poly (methyl methacrylate) (PMMA), acrylonitrile butadiene styrene (ABS), aliphatic or semi-aromatic polyamides, polylactic acid (polylactide) (PLA), polybenzimidazole (PBI), polycarbonate (PC), polyether sulfone (PES), polyetherimide, polyethylene (PE), polypropylene (PP), polymethylpentene (PMP) and polybutene-1 (PB-1), polystyrene (PS) and polyvinyl chloride (PVC). Polypropylene (PP) or polyethylene (PE) are generally preferred. The thermoplastic polymer may be a thermoplastic polyolefin. The thermoplastic polyolefin may be selected from a group consisting of: polyethylene (PE), polypropylene (PP), polymethylpentene (PMP) and polybutene-1 (PB-1). A preferred thermoplastic polyolefin is polyethylene (PE). The polyethylene may have a density range of 0.880-0.940 g/cm³. The polyethylene may have a density >0.940 g/cm³. The polyethylene may be selected from a group consisting of high-density polyethylene (HDPE), medium-density polyethylene (MDPE), linear low-density polyethylene (LLDPE), low-density polyethylene (LDPE) and very-low-density polyethylene (VLDPE). In an example embodiment, the thermoplastic polymer is high-density polyethylene (HDPE). The polyethylene may have a crystallinity of more than 30%, more than 35%, more than 40%, more than 45%, more than 50%, more than 55%, more than 60%, more than 65%, more than 70%, more than 75%, more than 80%, more than 85%, more than 90%. The polyethylene may be copolymerised with, for example, but-1-ene or hex-1-ene. The polymeric composition may comprise additives, such as fillers and/or colourants. In one example, the chamber comprises a polymeric composition comprising a thermoplastic polymer, having a wall thickness in a range from 0.5 mm to 10 mm, preferably in a range from 1 mm to 5 mm, for example 1.5 mm, 2 mm or 3 mm.

### First End and Second End

The chamber has the first end and the second end. It should be understood that the first end and the second end respectively comprise wall portions, for example a first wall portion and a second wall portion, respectively. The first end and the second end are mutually opposed. In one example, the first end comprises and/or is a planar end, a concave end and/or a convex end. In one example, the second end comprises and/or is a planar end, a concave end and/or a convex end. In one example, the first end and the second end are mutually parallel. It should be understood that the chamber comprises a wall portion, for example a third wall portion extending between the first end and the second end, for example between a first wall portion and a second wall portion of the first end and the second end, respectively. It should be understood that the chamber is impermeable, having no perforations therethrough, other than the inlet and the outlet. That is, the chamber is not a porous chamber.

### First Cylindrical Volume and Tapered Volume

In one example, a ratio of a length of the first cylindrical volume to a length of the tapered volume is in a range from 10:1 to 1:2, preferably in a range from 5:1 to 1:1, more preferably in a range from 4:1 to 2:1, for example about 5:2 or 5:2. In this way, generating of relatively high peripheral velocities and creating of a back pressure is further improved, thereby improving restricting of flow to the desired rate at a given head height. Increasing this ratio above 10:1 tends towards a conventional radial vortex flow control device while decreasing this ratio below 1:2 tends towards a conventional conical vortex flow control device, such that the advantages of the vortex flow control device according to the first aspect are relatively reduced. It should be understood that the respective lengths of the first cylindrical volume and the tapered volume are measured using respective central normals of respective cross-sectional areas thereof.

In one example, a ratio of a first cross-sectional area of the tapered volume relatively more proximal the first end to a second cross-sectional area of the tapered volume relatively more proximal the second end is in a range from 3:1 to 5:4, preferably in a range from 5:2 to 3:2, more preferably in a range from 9:4 to 7:4, for example about 2:1 or 2:1. In this way, generating of relatively high peripheral velocities and creating of a back pressure is further improved, thereby improving restricting of flow to the desired rate at a given head height. Increasing this ratio above 3:1 (i.e. reducing the taper angle) further lowers the head height required for initiation while decreasing this ratio below 5:4 (i.e. increasing the taper angle) further raises the head height required for initiation. The inventor has determined that the range from 3:1 to 5:4 is optimal for a broad range of head heights and flow rates for typical applications.

In one example, the first cylindrical volume comprises and/or is a circular cylindrical volume or an elliptical cylindrical volume. Circular cylindrical volumes are preferred for manufacturing. Nevertheless, elliptical cylindrical volumes are also suitable for vortex generation. It should be understood that the first cylindrical volume may be equivalently provided by a polyhedron, such as a triangular prism, a rectangular prism, a pentagonal prism, a hexagonal prism, a heptagonal prism, an octagonal prism, a nonagonal prism, a decagonal prism, more generally, a prism having polygonal caps. A polygonal cap tending towards a circular cap (i.e. having an increased number of sides) is preferred, for further improved vortex generation.

In one example, the tapered volume comprises and/or is a frustoconical volume and/or a truncated bell. A frustoconical volume (also known as a conical volume such as of a conventional conical vortex flow control device) is preferred, for further improved vortex generation. In one example, the frustoconical volume is a right circular conical frustum volume, for further improved vortex generation. In one example, the frustoconical volume is an oblique conical frustum volume.

In one example, the first cylindrical volume and the tapered volume are coaxial. In this way, flow through the chamber is further improved since vortex flow is relatively more symmetric. It should be understood that the respective axes of the first cylindrical volume and the tapered volume are defined by respective central normals of respective cross-sectional areas thereof. In one example, the first cylindrical volume and the tapered volume are not coaxial i.e. mutually offset, for example wherein the tapered volume comprises and/or is a right circular conical frustum volume having an axis mutually offset from the axis of the first cylindrical volume or wherein the tapered volume comprises and/or is an oblique conical frustum volume.

In one example, the first cylindrical volume and the outlet are coaxial and/or the tapered volume and the outlet are coaxial, as described above.

In one example, the first cylindrical volume and the tapered volume are mutually adjacent i.e. without any further volume disposed therebetween, such that the first cylindrical volume transitions, for example abruptly or smoothly, to the tapered volume. In this way, vortex flow initially generated in the first cylindrical volume is further generated in the tapered volume.

### Second Cylindrical Volume

In one example, the chamber defines a second cylindrical volume proximal to and/or at the second end. In this way, the tapered volume is disposed between the first cylindrical volume and the second cylindrical volume. In this way, vortex flow is stabilized before exiting via the outlet. In one example, the tapered volume and the second cylindrical volume are mutually adjacent i.e. without any further volume disposed therebetween, such that the tapered volume transitions, for example abruptly or smoothly, to the second cylindrical volume. In this way, vortex flow initially generated in the first cylindrical volume and further generated in the tapered volume is maintained to the outlet.

In one example, a ratio of a length of the first cylindrical volume to a length of the second cylindrical volume is in a range from 5:1 to 1:5, preferably in a range from 3:1 to 1:3, more preferably in a range from 2:1 to 1:2, for example about 1:1 or 1:1. In this way, generating of relatively high peripheral velocities and creating of a back pressure is further improved, thereby improving restricting of flow to the desired rate at a given head height. Increasing this ratio above 5:1 or decreasing this ratio below 1:5 is not preferred, such that the advantages of the vortex flow control device according to the first aspect are relatively reduced. The inventor has determined that the range from 5:1 to 1:5 is optimal for a broad range of head heights and flow rates for typical applications It should be understood that the respective lengths of the first cylindrical volume and the second cylindrical volume are measured using respective central normals of respective cross-sectional areas thereof.

In one example, the second cylindrical volume is externally sized, for example dimensioned and/or shaped, for coupling, for example directly, to a pipe of a storm water drainage system, such as having a standard size. In this way, compatibility of the vortex flow control device with storm water drainage systems is improved. In one example, a diameter, for example an external diameter, of the second cylindrical volume is in a range from 10 mm to 600 mm, preferably in a range from 20 mm to 300 mm, more preferably in a range from 32 mm to 110 mm. It should be understood that the diameter of the inlet may be a nominal diameter, as understood by the skilled person.

### Inlet and Outlet

The chamber has the inlet (for example an orifice, an aperture, a hole, a perforation, a passageway, a pipe; also known as an intake or entrance) proximal to and/or at the first end. The inlet is tangential, more generally non-radial, to the first cylindrical volume. In one example, the inlet is provided through a third wall portion extending between the first end and the second end, for example between a first wall portion and a second wall portion of the first end and the second end, respectively. In one example, the inlet is not provided in a first wall of the first end.

The chamber has the outlet (for example an orifice, an aperture, a hole, a perforation, a passageway, a pipe; also known as an outtake or exit) proximal to and/or at the second end. In one example, the outlet is provided in a second wall of the second end.

The inlet and the outlet are mutually orthogonal, more generally mutually transverse. It should be understood that respective axes of the inlet and the outlet may be coplanar or in mutually parallel planes. It should be understood that the respective axes of the inlet and the outlet are defined by respective central normals of respective cross-sectional areas thereof.

In one example, the inlet comprises and/or is a flared inlet. It should be understood that the flared inlet flares towards the first cylindrical volume i.e. flares outwardly, such that a cross-sectional area of the flared inlet increases towards the first cylindrical volume and hence increases in a direction of flow of a fluid therethrough. In this way, flow of a fluid into the first cylindrical volume is improved while a cross-sectional area of the flared inlet may be varied, as described below, for example by cutting and/or by insertion or removal of inlet adapters. In one example, the flared inlet comprises and/or is a frustoconical inlet or a bell-mouth inlet.

In one example, the flared inlet comprises a set of cutting guides, including a first cutting guide. In one example, the set of cutting guides includes a plurality of cutting guides, for example corresponding with predetermined cross-sectional areas, design head heights and/or design flow rates. In this way, a cross-sectional area of the flared inlet may be varied by cutting, for example in situ for a particular installation and/or may be reselected if design requirements change, such as increased or decreased attenuation. The inventor has determined that the design flow and the design head of the vortex flow control device may be varied by varying the respective cross-sectional areas of the inlet and/or the outlet, thereby altering the head at which the flush point and the initiation point occur. In contrast with conventional radial vortex flow control devices and conventional conical vortex flow control devices, such variations in the respective cross-sectional areas of the inlet and/or the outlet may be used to adapt a relatively limited number of standard sizes, may be performed in situ for a particular installation and/or may be reselected if design requirements change, such as increased or decreased attenuation. In one example, the inlet, for example wherein the inlet comprises and/or is a flared inlet, comprises and/or is a replaceable inlet, for example a push fit inlet, a screw fit inlet or a bayonet fit inlet. In this way, the inlet may be replaced with an inlet having a different cross-sectional area, for example for a particular design head height and/or a particular design flow rate.

In one example, the outlet comprises and/or is a tapered outlet. It should be understood that the tapered outlet tapers inwardly away from the tapered volume i.e. such that a cross-sectional area of the tapered outlet reduces away from the tapered volume and hence reduces in a direction of flow of a fluid therethrough. In this way, flow of a fluid from the tapered volume is improved while a cross-sectional area of the tapered outlet may be varied, as described below, for example by cutting and/or by insertion or removal of outlet adapters. In one example, the tapered outlet comprises and/or is a frustoconical outlet or a bell-mouth outlet.

In one example, the tapered outlet comprises a set of cutting guides, including a first cutting guide. In one example, the set of cutting guides includes a plurality of cutting guides, for example corresponding with predetermined cross-sectional areas, design head heights and/or design flow rates. In this way, a cross-sectional area of the tapered outlet may be varied by cutting, for example in situ for a particular installation and/or may be reselected if design requirements change, such as increased or decreased attenuation. The inventor has determined that the design flow and the design head of the vortex flow control device may be varied by varying the respective cross-sectional areas of the inlet and/or the outlet, thereby altering the head at which the flush point and the initiation point occur. In contrast with conventional radial vortex flow control devices and conventional conical vortex flow control devices, such variations in the respective cross-sectional areas of the inlet and/or the outlet may be used to adapt a relatively limited number of standard sizes, may be performed in situ for a particular installation and/or may be reselected if design requirements change, such as increased or decreased attenuation. In one example, the outlet, for example wherein the outlet comprises and/or is a tapered outlet, comprises and/or is a replaceable outlet, for example a push fit outlet, a screw fit outlet or a bayonet fit outlet. In this way, the outlet may be replaced with an outlet having a different cross-sectional area, for example for a particular design head height and/or a particular design flow rate.

In one example, the outlet is externally sized, for example dimensioned and/or shaped, for coupling, for example directly, to a pipe of a storm water drainage system, such as having a standard size. In this way, compatibility of the vortex flow control device with storm water drainage systems is improved.

In one example, a ratio of a cross-sectional area of the inlet to a cross-sectional area of the outlet is in a range from 5:1 to 1:5, preferably in a range from 4:1 to 1:4, more preferably in a range from 3:1 to 1:3, most preferably in a range from 2:1 to 1:2, for example about 1:1 or 1:1. The inventor has determined that the respective cross-sectional areas of the inlet and the outlet may be varied independently or dependently to be different or the same. It should be understood that the respective cross-sectional areas of the inlet and the outlet are the minima thereof, for example if the inlet comprises and/or is a flared inlet and/or the outlet comprises and/or is a tapered outlet.

In one example, a diameter of the inlet is in a range from 10 mm to 600 mm, preferably in a range from 20 mm to 300 mm, more preferably in a range from 32 mm to 110 mm. It should be understood that the diameter of the inlet may be a nominal diameter, as understood by the skilled person.

In one example, a diameter of the outlet is in a range from 10 mm to 600 mm, preferably in a range from 20 mm to 300 mm, more preferably in a range from 32 mm to 110 mm. It should be understood that the diameter of the outlet may be a nominal diameter, as understood by the skilled person.

In one example, the inlet is arranged proximal or at a lowest level of the first cylindrical volume, such that a relatively small or no sump is formed in the first cylindrical volume, for example spaced less than 5 mm, less than 10 mm, less than 15 mm, less than 20 mm, less than 25 mm, less than 30 mm, less than 40 mm or less than 50 mm above the lowest level of the first cylindrical volume. In one preferred example, the inlet is arranged at a lowest level of the first cylindrical volume, such that no sump is formed in the first cylindrical volume.

In one example, the chamber has a plurality of inlets, for example as described with respect to the inlet. For example, the chamber may have two, three, four or more inlets. In one example, the chamber has only one inlet i.e. a single inlet. In one example, the chamber has a plurality of outlets, for example as described with respect to the outlet. For example, the chamber may have two, three, four or more outlets. In one example, the chamber has only one outlet i.e. a single outlet.

### Port

In one example, the chamber has a port (also known as an access aperture) for accessing therein, for example for inspection and/or maintenance. It should be understood that the port is a closable port i.e. having a sealed cover, for example a hermetically sealed cover.

### Flow Control Chamber

The second aspect provides a flow control chamber (also known as a flow control manhole) comprising a vortex flow control device according to the first aspect, for example a conventional flow control chamber comprising a vortex flow control device according to the first aspect. Conventional flow control chambers are known. Typically, flow control chambers are used to regulate the flow of storm water in a drainage system preventing downstream flooding during periods of heavy rainfall.

### Attenuation Tank

The third aspect provides an attenuation tank comprising a vortex flow control device according to the first aspect, for example a conventional attenuation tank comprising a vortex flow control device according to the first aspect. Conventional attenuation tanks are known.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1A schematically depicts a conventional radial vortex flow control device; FIG. 1B schematically depicts a conventional conical (also known as cone shaped) vortex flow control device; and FIG. 1C shows a typical discharge curve of a conventional vortex flow control device, showing a bistable characteristic thereof.

FIG. 2A is a CAD perspective view of a vortex flow control device according to an exemplary embodiment; FIG. 2B is a CAD plan elevation view of the vortex flow control device from above; FIG. 2C is a CAD right side elevation view of the vortex flow control device; FIG. 2D is a CAD plan elevation view of the vortex flow control device from below; FIG. 2E is a CAD left side elevation view of the vortex flow control device; FIG. 2F is a CAD front elevation view of the vortex flow control device; and FIG. 2G is a CAD front elevation view of the vortex flow control device;

FIG. 3A is a CAD perspective view of a vortex flow control device according to an exemplary embodiment;

FIG. 4A is a CAD perspective view of a vortex flow control device according to an exemplary embodiment;

FIG. 5A is a CAD perspective view of a vortex flow control device according to an exemplary embodiment;

FIG. 6A is a CAD perspective view of a vortex flow control device according to an exemplary embodiment;

FIG. 7 shows discharge curves of vortex flow control devices according to exemplary embodiments;

FIG. 8A is a CAD perspective view, from below, of a vortex flow control device according to an exemplary embodiment; FIG. 8B is a CAD plan elevation view of the vortex flow control device from above; FIG. 8C is a CAD right side elevation view of the vortex flow control device; FIG. 8D is a CAD left side elevation view of the vortex flow control device; FIG. 8E is a CAD front elevation view of the vortex flow control device; and FIG. 8F is a CAD sectional view (section A-A of FIG. 8E) of the vortex flow control device; and

FIG. 9 shows discharge curves of vortex flow control devices according to exemplary embodiments.

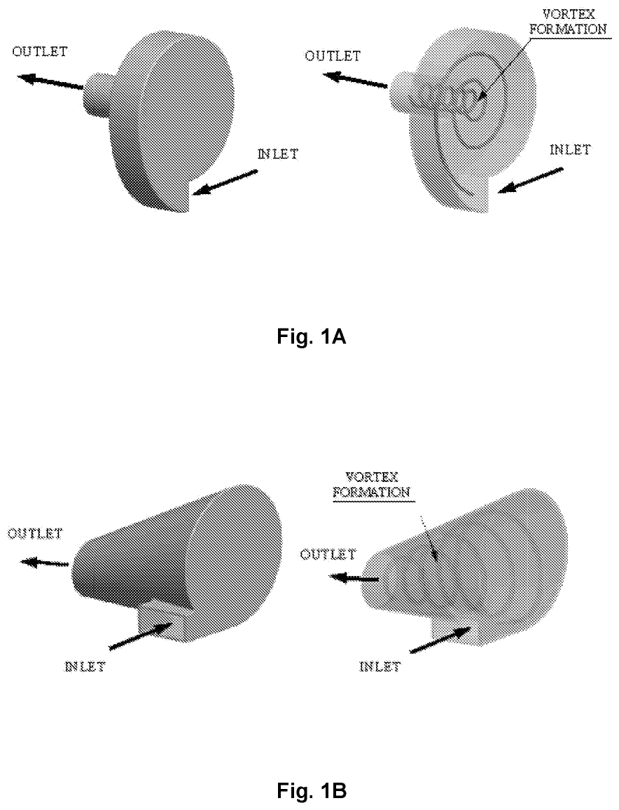

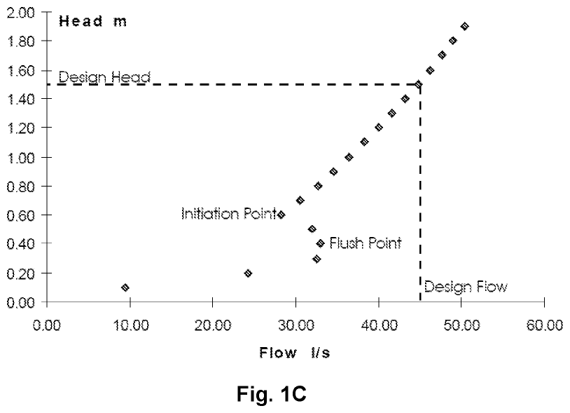

### DETAILED DESCRIPTION OF THE DRAWINGS

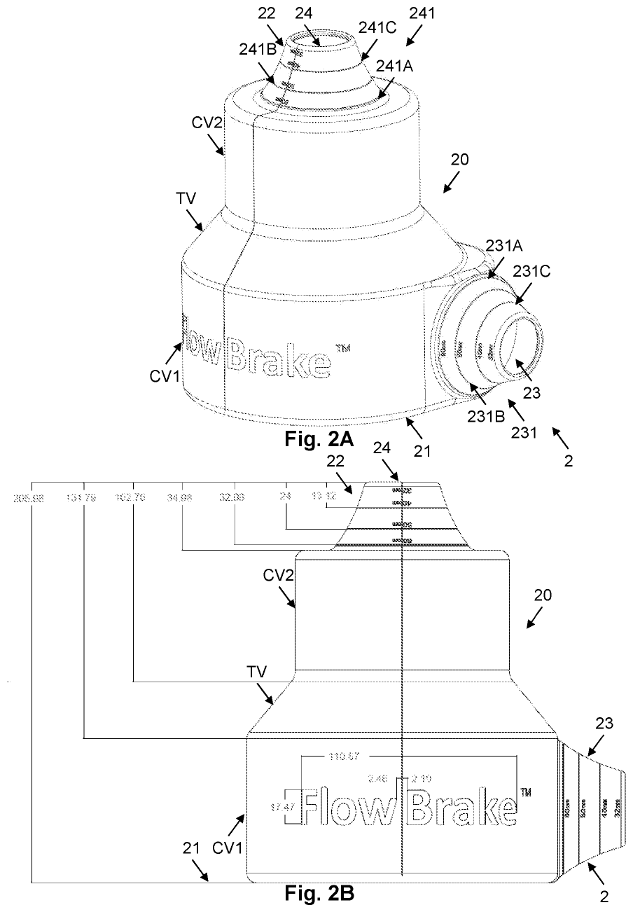

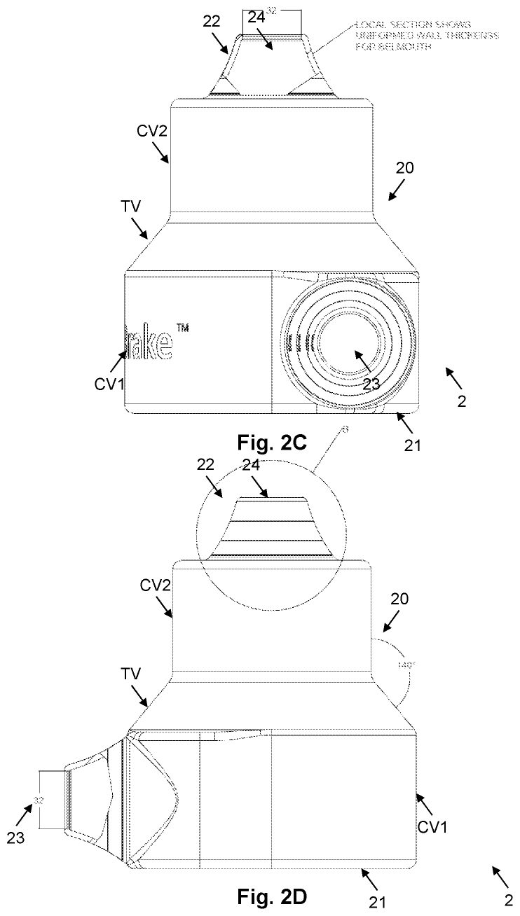

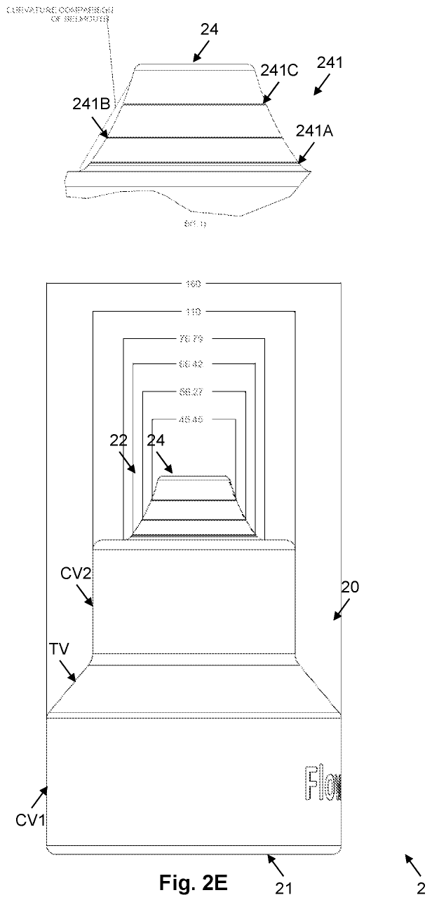

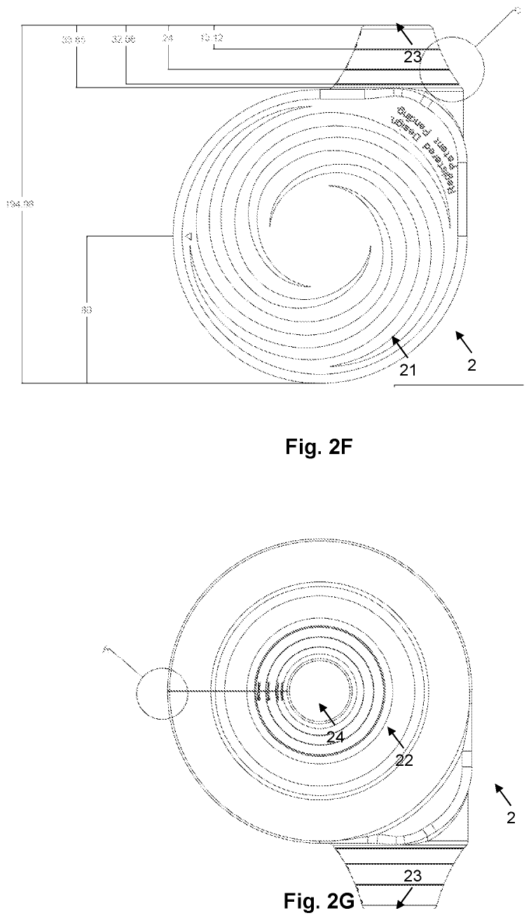

FIG. 2A is a CAD perspective view of a vortex flow control device 2 according to an exemplary embodiment; FIG. 2B is a CAD plan elevation view of the vortex flow control device 2 from above; FIG. 2C is a CAD right side elevation view of the vortex flow control device 2; FIG. 2D is a CAD plan elevation view of the vortex flow control device 2 from below; FIG. 2E is a CAD left side elevation view of the vortex flow control device 2; FIG. 2F is a CAD front elevation view of the vortex flow control device 2; and FIG. 2G is a CAD front elevation view of the vortex flow control device 2.

The vortex flow control device 2 comprises a chamber 20, having a first end 21, a second end 22, an inlet 23 proximal to and/or at the first end 21 and an outlet 24 proximal to and/or at the second end 22, wherein the first end 21 and the second end 22 are mutually opposed and wherein the inlet 23 and the outlet 24 are mutually orthogonal;
wherein the chamber 20 defines a first cylindrical volume CV1 proximal to and/or at the first end 21 and wherein the inlet 23 is tangential to the first cylindrical volume CV1; and
wherein the chamber 20 defines a tapered volume TV disposed between the first cylindrical volume CV1 and the outlet 24.

In this example, the total internal volume of the chamber 20 comprises the first cylindrical volume CV1, the tapered volume TV and a second cylindrical volume CV2, for example proximal to and/or at the second end 22 as described below. In this example, the total internal volume of the chamber 20 consists of the first cylindrical volume CV1, the tapered volume TV and the second cylindrical volume CV2, for example proximal to and/or at the second end 22 as described below. In this example, an external shape of the chamber 20 corresponds with the internal volume(s) of the chamber 20.

In this example, the vortex flow control device 2 comprises and/or is a moulded and/or a monolithic (i.e. unitary, one-piece) vortex flow control device 2, provided by moulding a polymeric composition comprising a thermoplastic polymer, particularly PE, having a constant wall thickness in a range from 0.5 mm to 10 mm, preferably in a range from 1 mm to 5 mm, for example 1.5 mm, 2 mm or 3 mm.

In this example, the first end 21 comprises is a planar end. In this example, the second end 22 comprises is a planar end. In this example, the first end 21 and the second end 22 are mutually parallel.

In this example, a ratio of a length of the first cylindrical volume CV1 to a length of the tapered volume TV is about 5:2.

In this example, a ratio of a first cross-sectional area of the tapered volume TV relatively more proximal the first end 21 to a second cross-sectional area of the tapered volume TV relatively more proximal the second end 22 is about 2:1.

In this example, the first cylindrical volume CV1 is a circular cylindrical volume.

In this example, the tapered volume TV a frustoconical volume. In this example, the frustoconical volume is a right circular conical frustum volume.

In this example, the first cylindrical volume CV1 and the tapered volume TV are coaxial.

In this example, the first cylindrical volume CV1 and the outlet 24 are coaxial and the tapered volume TV and the outlet 24 are coaxial, as described above.

In this example, the first cylindrical volume CV1 and the tapered volume TV are mutually adjacent i.e. without any further volume disposed therebetween, such that the first cylindrical volume CV1 transitions smoothly to the tapered volume TV.

In this example, the chamber 20 defines a second cylindrical volume CV2 proximal to and/or at the second end 22. In this example, the tapered volume TV and the second cylindrical volume CV2 are mutually adjacent i.e. without any further volume disposed therebetween, such that the tapered volume TV transitions smoothly to the second cylindrical volume CV2.

In this example, a ratio of a length of the first cylindrical volume CV1 to a length of the second cylindrical volume CV2 is about 1:1.

In this example, the second cylindrical volume CV2 is externally sized, for example dimensioned and/or shaped, for coupling, for example directly, to a pipe of a storm water drainage system, such as having a standard size.

The inlet 23 is tangential, more generally non-radial, to the first cylindrical volume CV1. In this example, the inlet 23 is provided through a third wall portion extending between the first end 21 and the second end 22, for example between a first wall portion and a second wall portion of the first end 21 and the second end 22, respectively. In this example, the inlet 23 is not provided in a first wall of the first end 21.

In this example, the outlet 24 is provided in a second wall of the second end 22.

The inlet 23 and the outlet 24 are mutually orthogonal, more generally mutually transverse.

In this example, the inlet 23 comprises and/or is a flared inlet 23. In this example, the flared inlet 23 is a bell-mouth inlet 23.

In this example, the flared inlet 23 comprises a set of cutting guides 231 (231A, 231B, 231C), including a first cutting guide 231A. In this example, the set of cutting guides 231 (231A, 231B, 231C) includes a plurality (3) of cutting guides, for example corresponding with predetermined cross-sectional areas, design head heights and/or design flow rates.

In this example, the outlet 24 comprises and/or is a tapered outlet 24. In this example, the tapered outlet 24 is a bell-mouth outlet 24.

In this example, a diameter of the inlet 23 is 32 mm and a diameter of the outlet 24 is 32 mm.

In this example, the tapered outlet 24 comprises a set of cutting guides 241 (241A, 241B, 241C), including a first cutting guide 241A. In this example, the set of cutting guides 241 (241A, 241B, 241C) includes a plurality (3) of cutting guides, for example corresponding with predetermined cross-sectional areas, design head heights and/or design flow rates.

In this example, a ratio of a cross-sectional area of the inlet 23 to a cross-sectional area of the outlet 24 is 1:1.

In this example, the inlet 23 is arranged at a lowest level of the first cylindrical volume CV1, such that no sump is formed in the first cylindrical volume CV.

In this example, the chamber 20 has only one inlet 23 i.e. a single inlet 23. In this example, the chamber 20 has only one outlet 24 i.e. a single outlet 24.

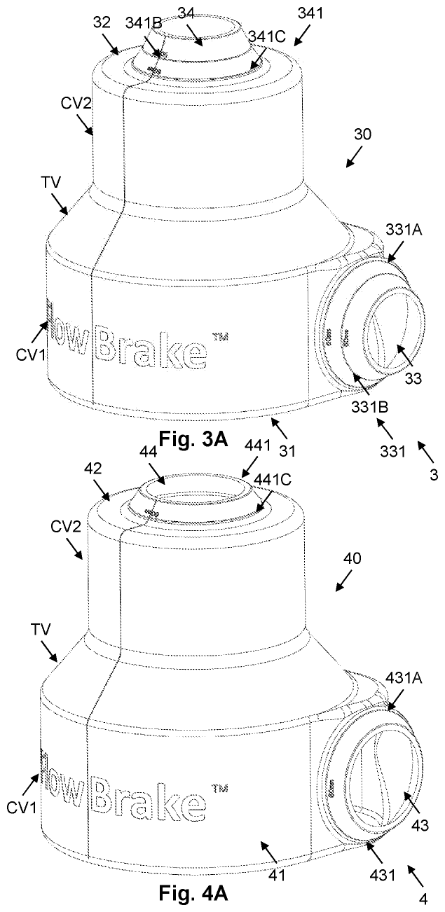

FIG. 3A is a CAD perspective view of a vortex flow control device 3 according to an exemplary embodiment. The vortex flow control device 3 is generally as described with respect to the vortex flow control device 2. Like reference signs denote like features.

In this example, a diameter of the inlet 33 is 40 mm and a diameter of the outlet 34 is 40 mm.

FIG. 4A is a CAD perspective view of a vortex flow control device 4 according to an exemplary embodiment. The vortex flow control device 4 is generally as described with respect to the vortex flow control device 2. Like reference signs denote like features.

In this example, a diameter of the inlet 43 is 50 mm and a diameter of the outlet 44 is 50 mm.

FIG. 5A is a CAD perspective view of a vortex flow control device 5 according to an exemplary embodiment. The vortex flow control device 5 is generally as described with respect to the vortex flow control device 2. Like reference signs denote like features.

In this example, a diameter of the inlet 53 is 60 mm and a diameter of the outlet 54 is 60 mm.

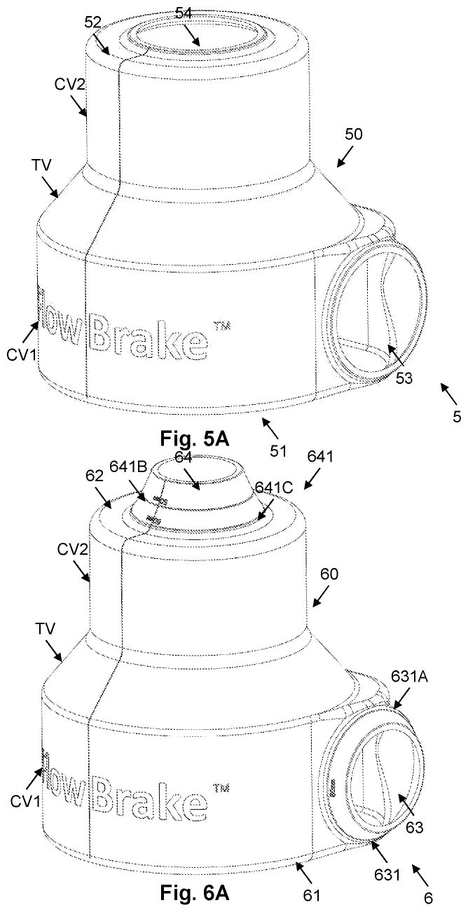

FIG. 6A is a CAD perspective view of a vortex flow control device 6 according to an exemplary embodiment. The vortex flow control device 6 is generally as described with respect to the vortex flow control device 2. Like reference signs denote like features.

In this example, a diameter of the inlet 63 is 50 mm and a diameter of the outlet 64 is 40 mm.

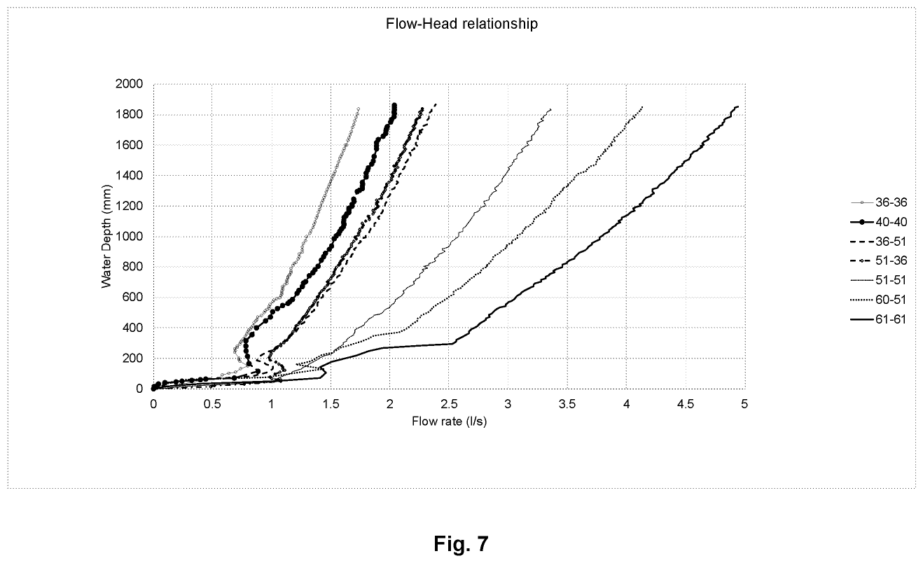

FIG. 7 shows discharge curves of vortex flow control devices according to exemplary embodiments. The vortex flow control devices are generally as described with respect to the vortex flow control device 2. The vortex flow control devices are identical, other than having inlet and outlet diameters as indicated (denoted inlet diameter-outlet diameter, in mm).

The respective discharge curves are “S” shaped. Increasing the diameter of the inlet and/or the outlet moves the flush point and the initiation point to relatively higher flow rates at relatively lower corresponding heads. In this way, the design flow and the design head of the vortex flow control device may be varied by varying the respective cross-sectional areas of the inlet and/or the outlet, thereby altering the head at which the flush point and the initiation point occur. In this way, the vortex flow control device may be used for a very wide range of flow rates, by varying the respective cross-sectional areas of the inlet and/or the outlet accordingly. For example, for the 61-61 vortex flow control device, the design head may be as low as about 350 mm for a design flow of about 2.5 l/s while for the 36-36 vortex flow control device, the design head may be as low as about 600 mm for a design flow of about 1 l/s.

Consider, for example, the similar respective discharge curves for the 36-51 vortex flow control device and for the 51-36 vortex flow control device, compared with the respective discharge curves for the 36-36 vortex flow control device and for the 51-51 vortex flow control device.

That is, increasing only the inlet diameter from 36 mm to 51 mm and increasing only the outlet diameter from 36 mm to 51 mm similarly increase the design flow and alter the head at which the flush point and the initiation point occur of the respective vortex flow control devices.

Increasing both the inlet diameter from 36 mm to 51 mm and the outlet diameter from 36 mm to 51 mm further increases the design flow and alters the head at which the flush point and the initiation point occur of the respective vortex flow control devices

That is, generally, the design flow and the design head of the vortex flow control device may be varied by varying the inlet diameter or by varying the outlet diameter or both varying the inlet diameter and the outlet diameter.

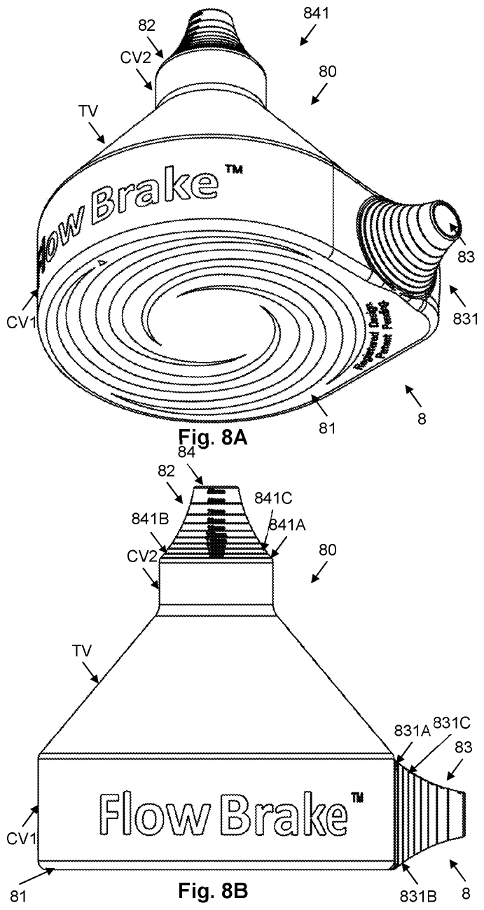

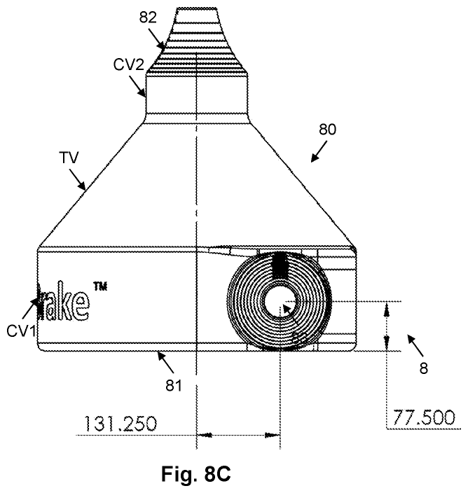

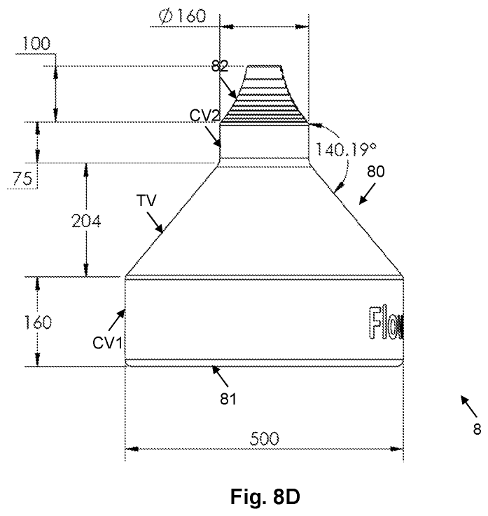

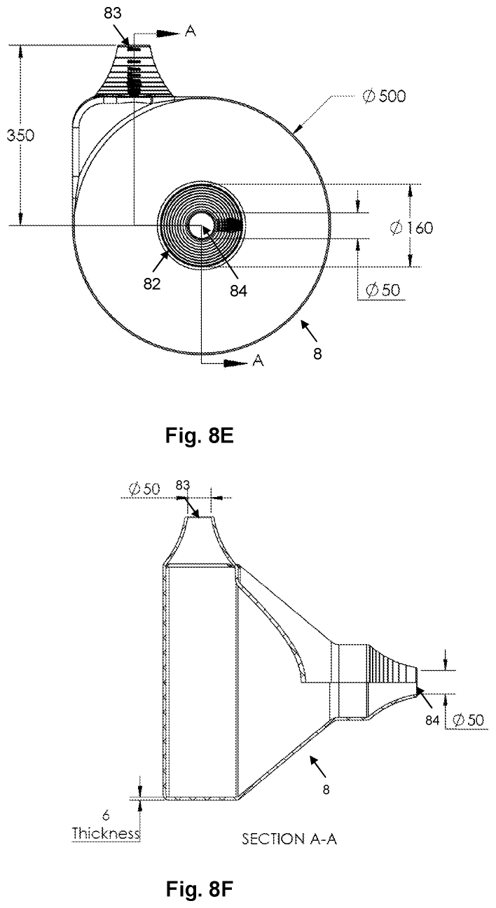

FIG. 8A is a CAD perspective view, from below, of a vortex flow control device 8 according to an exemplary embodiment; FIG. 8B is a CAD plan elevation view of the vortex flow control device 8 from above; FIG. 8C is a CAD right side elevation view of the vortex flow control device 8; FIG. 8D is a CAD left side elevation view of the vortex flow control device 8; FIG. 8E is a CAD front elevation view of the vortex flow control device 8; and FIG. 8F is a CAD sectional view (section A-A of FIG. 8E) of the vortex flow control device 8.

The vortex flow control device 8 is generally as described with respect to the vortex flow control device 2. Like reference signs denote like features. The vortex flow control device 8 is relatively larger than the vortex flow control device 2, as shown by the respective dimensions, and provides for relatively higher flow.

The vortex flow control device 8 comprises a chamber 80, having a first end 81, a second end 82, an inlet 83 proximal to and/or at the first end 81 and an outlet 84 proximal to and/or at the second end 82, wherein the first end 81 and the second end 82 are mutually opposed and wherein the inlet 83 and the outlet 84 are mutually orthogonal;
wherein the chamber 80 defines a first cylindrical volume CV1 proximal to and/or at the first end 81 and wherein the inlet 83 is tangential to the first cylindrical volume CV1; and
wherein the chamber 80 defines a tapered volume TV disposed between the first cylindrical volume CV1 and the outlet 84.

In this example, the total internal volume of the chamber 80 comprises the first cylindrical volume CV1, the tapered volume TV and a second cylindrical volume CV2, for example proximal to and/or at the second end 82 as described below. In this example, the total internal volume of the chamber 80 consists of the first cylindrical volume CV1, the tapered volume TV and the second cylindrical volume CV2, for example proximal to and/or at the second end 82 as described below. In this example, an external shape of the chamber 80 corresponds with the internal volume(s) of the chamber 80.

In this example, the vortex flow control device 8 comprises and/or is a moulded and/or a monolithic (i.e. unitary, one-piece) vortex flow control device 8, provided by moulding a polymeric composition comprising a thermoplastic polymer, particularly PE, having a constant wall thickness in a range from 0.5 mm to 10 mm, particularly 6 mm.

In this example, the first end 81 comprises is a planar end. In this example, the second end 82 comprises is a planar end. In this example, the first end 81 and the second end 82 are mutually parallel.

In this example, a ratio of a length of the first cylindrical volume CV1 to a length of the tapered volume TV is about 4:5.

In this example, a ratio of a first cross-sectional area of the tapered volume TV relatively more proximal the first end 81 to a second cross-sectional area of the tapered volume TV relatively more proximal the second end 82 is about 10:1.

In this example, the first cylindrical volume CV1 is a circular cylindrical volume.

In this example, the tapered volume TV a frustoconical volume. In this example, the frustoconical volume is a right circular conical frustum volume.

In this example, the first cylindrical volume CV1 and the tapered volume TV are coaxial.

In this example, the first cylindrical volume CV1 and the outlet 84 are coaxial and the tapered volume TV and the outlet 84 are coaxial, as described above.

In this example, the first cylindrical volume CV1 and the tapered volume TV are mutually adjacent i.e. without any further volume disposed therebetween, such that the first cylindrical volume CV1 transitions smoothly to the tapered volume TV.

In this example, the chamber 80 defines a second cylindrical volume CV2 proximal to and/or at the second end 82. In this example, the tapered volume TV and the second cylindrical volume CV2 are mutually adjacent i.e. without any further volume disposed therebetween, such that the tapered volume TV transitions smoothly to the second cylindrical volume CV2.

In this example, a ratio of a length of the first cylindrical volume CV1 to a length of the second cylindrical volume CV2 is about 2:1.

In this example, the second cylindrical volume CV2 is externally sized, for example dimensioned and/or shaped, for coupling, for example directly, to a pipe of a storm water drainage system, such as having a standard size.

The inlet 83 is tangential, more generally non-radial, to the first cylindrical volume CV1. In this example, the inlet 83 is provided through a third wall portion extending between the first end 81 and the second end 82, for example between a first wall portion and a second wall portion of the first end 81 and the second end 82, respectively. In this example, the inlet 83 is not provided in a first wall of the first end 81.

In this example, the outlet 84 is provided in a second wall of the second end 82.

The inlet 83 and the outlet 84 are mutually orthogonal, more generally mutually transverse.

In this example, the inlet 83 comprises and/or is a flared inlet 83. In this example, the flared inlet 83 is a bell-mouth inlet 83.

In this example, the flared inlet 83 comprises a set of cutting guides 831 (831A, 831B, 831C), including a first cutting guide 831A. In this example, the set of cutting guides 831 (831A, 831B, 831C) includes a plurality (9) of cutting guides (noting only three cutting guides 831A, 831B, 831C are provided with reference signs, for clarity), for example corresponding with predetermined cross-sectional areas, design head heights and/or design flow rates.

In this example, the outlet 84 comprises and/or is a tapered outlet 84. In this example, the tapered outlet 84 is a bell-mouth outlet 84.

In this example, a diameter of the inlet 83 is 50 mm and a diameter of the outlet 84 is 50 mm.

In this example, the tapered outlet 84 comprises a set of cutting guides 841 (241A, 841B, 841C), including a first cutting guide 841A. In this example, the set of cutting guides 841 (241A, 841B, 841C) includes a plurality (3) of cutting guides, for example corresponding with predetermined cross-sectional areas, design head heights and/or design flow rates.

In this example, a ratio of a cross-sectional area of the inlet 83 to a cross-sectional area of the outlet 84 is 1:1.

In this example, the inlet 83 is arranged at a lowest level of the first cylindrical volume CV1, such that no sump is formed in the first cylindrical volume CV.

In this example, the chamber 80 has only one inlet 83 i.e. a single inlet 83. In this example, the chamber 80 has only one outlet 84 i.e. a single outlet 84.

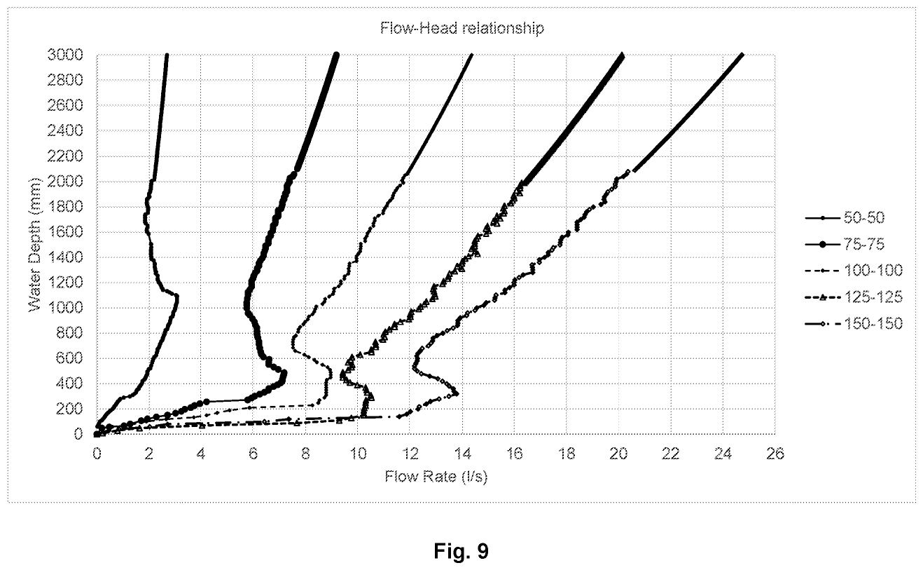

FIG. 9 shows discharge curves of vortex flow control devices according to exemplary embodiments.

The vortex flow control devices are generally as described with respect to the vortex flow control device 8. The vortex flow control devices are identical, other than having inlet and outlet diameters as indicated (denoted inlet diameter-outlet diameter, in mm).

The respective discharge curves are “S” shaped. Increasing the diameter of the inlet and/or the outlet moves the flush point and the initiation point to relatively higher flow rates at relatively lower corresponding heads. In this way, the design flow and the design head of the vortex flow control device may be varied by varying the respective cross-sectional areas of the inlet and/or the outlet, thereby altering the head at which the flush point and the initiation point occur. In this way, the vortex flow control device may be used for a very wide range of flow rates, by varying the respective cross-sectional areas of the inlet and/or the outlet accordingly. For example, for the 150-150 vortex flow control device, the design head may be as low as about 600 mm for a design flow of about 12 l/s while for the 75-75 vortex flow control device, the design head may be as low as about 1000 mm for a design flow of about 6 l/s.

Although a preferred embodiment has been shown and described, it will be appreciated by those skilled in the art that various changes and modifications might be made without departing from the scope of the invention, as defined in the appended claims and as described above.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at most some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. A vortex flow control device, the vortex flow control device comprising:
a chamber, the chamber having a first end, a second end, an inlet proximal to and/or at the first end, and an outlet proximal to and/or at the second end, the first end and the second end being mutually opposed and the inlet and the outlet being mutually orthogonal,
the chamber defining a first cylindrical volume proximal to and/or at the first end and the inlet being tangential to the first cylindrical volume;
the chamber defining a tapered volume disposed between the first cylindrical volume and the outlet; and
the inlet comprising and/or being a flared inlet and/or the outlet comprising and/or being a tapered outlet.

2. The vortex flow control device according to claim 1, wherein a ratio of a length of the first cylindrical volume to a length of the tapered volume is in a range from 10:1 to 1:2.

3. The vortex flow control device according to claim 1, wherein a ratio of a first cross-sectional area of the tapered volume relatively more proximal the first end to a second cross-sectional area of the tapered volume relatively more proximal the second end is in a range from 3:1 to 5:4.

4. The vortex flow control device according to claim 1, wherein the first cylindrical volume comprises and/or is a circular cylindrical volume.

5. The vortex flow control device according to claim 1, wherein the tapered volume comprises and/or is a frustoconical volume.

6. (canceled)

7. The vortex flow control device according to claim 1, wherein the first cylindrical volume and the tapered volume are coaxial.

8. The vortex flow control device according to claim 1, wherein the first cylindrical volume and the outlet are coaxial.

9. The vortex flow control device according to claim 1, wherein the first cylindrical volume and the tapered volume are mutually adjacent.

10. The vortex flow control device according to claim 1, wherein the chamber defines a second cylindrical volume proximal to and/or at the second end.

11. The vortex flow control device according to claim 10, wherein a ratio of a length of the first cylindrical volume to a length of the second cylindrical volume is in a range from 5:1 to 1:5.

12. (canceled)

13. The vortex flow control device according to claim 1, wherein the flared inlet comprises and/or is a replaceable inlet.

14. The vortex flow control device according to claim 1, wherein the flared inlet comprises and/or is a frustoconical inlet or a bell-mouth inlet.

15. The vortex flow control device according to claim 1, wherein the flared inlet comprises a set of cutting guides.

16. The vortex flow control device according to claim 1, wherein the tapered outlet comprises and/or is a replaceable outlet.

17. The vortex flow control device according to claim 1, wherein the tapered outlet comprises and/or is a frustoconical outlet or a bell-mouth outlet.

18. The vortex flow control device according to claim 1, wherein the tapered outlet comprises a set of cutting guides.

19. The vortex flow control device according to claim 1, wherein a ratio of a cross-sectional area of the inlet to a cross-sectional area of the outlet is in a range from 5:1 to 1:5.

20. A flow control chamber comprising a vortex flow control device according to claim 1.

21. An attenuation tank comprising a vortex flow control device according to claim 1.

22. The vortex flow control device according to claim 1, wherein the tapered volume and the outlet are coaxial.
